(19) United States
(12) Patent Application Publication
(10) Pub. No.: US 2019/0059045 A1
(43) Pub. Date: Feb. 21, 2019

(54) Cell indication for core network connectivity

(71) Applicant: MEDIATEK INC., Hsinchu (TW)

(72) Inventors: Chien-Chun Huang-Fu, Hsinchu (TW); Li-Chuan Tseng, Hsinchu (TW)

(73) Assignee: MEDIATEK INC.

(21) Appl. No.: 15/999,197

(22) Filed: Aug. 16, 2018

Related U.S. Application Data
(60) Provisional application No. 62/546,034, filed on Aug. 16, 2017.

(51) Int. Cl. H04W 48/16; H04W 48/20; H04W 36/08; H04W 24/10; H04W 48/10

(52) U.S. Cl. CPC H04W 48/16; H04W 48/20; H04W 48/10; H04W 24/10; H04W 36/08

(57) ABSTRACT

A method of providing two cell barring indications via system information for UE cell selection or reselection is proposed. A first indication is a “cellBarred” indication for EPC, which indicates wither UE is barred to access EPC core network, and a second indication is a “cellBarred5GS” indication for 5GC, which indicates whether UE is barred to access 5GC core network. For E-UTRAN cell connected to both EPC and 5GC, the two indications are determined on demand, based on network preference and congestion control. For E-UTRAN cell connected to 5GC only, the value of the “cellBarred” indication is always barred. For E-UTRAN cell connected to EPC only, the base station may omit the “cellBarred5GS” field, and the existence of “cellBarred5GS” can act as an indication whether the E-UTRAN connects to 5GC.

### CROSS REFERENCE TO RELATED APPLICATIONS

This application claims priority under 35 U.S.C. § 119 from U.S. Provisional Application No. 62/546,034, entitled “Enhancement of Voice Domain Selection (VDS) in 5GS”, filed on Aug. 16, 2017, the subject matter of which is incorporated herein by reference.

### TECHNICAL FIELD

The disclosed embodiments relate generally to wireless communication, and, more particularly, to method of supporting multimedia services in next generation mobile communication systems.

### BACKGROUND

The wireless communications network has grown exponentially over the years. A Long-Term Evolution (LTE) system offers high peak data rates, low latency, improved system capacity, and low operating cost resulting from simplified network architecture. LTE systems, also known as the 4G system, also provide seamless integration to older wireless network, such as GSM, CDMA and Universal Mobile Telecommunication System (UMTS). In LTE systems, an evolved universal terrestrial radio access network (E-UTRAN) includes a plurality of evolved Node-Bs (eNodeBs or eNBs) communicating with a plurality of mobile stations, referred to as user equipments (UEs). The 3^{rd} generation partner project (3GPP) network normally includes a hybrid of 2G/3G/4G systems. With the optimization of the network design, many improvements have developed over the evolution of various standards.

The signal bandwidth for next generation 5G new radio (NR) systems is estimated to increase to up to hundreds of MHz for below 6 GHz bands and even to values of GHz in case of millimeter wave bands. Furthermore, the NR peak rate requirement can be up to 20 Gbps, which is more than ten time of LTE. Three main application in 5G NR systems include enhanced Mobile Broadband (eMBB), Ultra-Reliable Low Latency Communication (URLLC), and massive Machine-Type Communication (MTC) under millimeter wave technology, small cell access, and unlicensed spectrum transmission. Multiplexing of eMDD & URLLC within a carrier is also supported.

An E-UTRAN serving cell is capable of connecting to an evolved packet core (EPC) under 4G LTE, a 5G core (5GC) under 5G NR, or both. Different core networks support different Non-Access Stratum (NAS) level signaling. Legacy LTE UE only supports 4G NAS signaling, while NR UE supports both 4G and 5G NAS signaling. When a legacy LTE UE selects an E-UTRAN cell that is only connected to 5GC, the legacy LTE UE does not support 5G NAS signaling for accessing the 5GC. It is not clear how UE can detect whether a cell is connected to EPC only, 5GC only, or both. As a result, the legacy LTE UE cannot access the core network until it tries to select or reselect the E-UTRAN serving cell that is only connected the 5GC.

A solution is sought for the access network to provide indication to UE such that UE can perform cell selection and/or reselection to the proper core network via the selected serving cell.

### SUMMARY

A method of providing two cell barring indications via system information for UE cell selection or reselection is proposed. A first indication is a “cellBarred” indication for EPC, which indicates wither UE is barred to access EPC core network, and a second indication is a “cellBarred5GS” indication for 5GC, which indicates whether UE is barred to access 5GC core network. For E-UTRAN cell connected to both EPC and 5GC, the two indications are determined on demand, based on network preference and congestion control. For E-UTRAN cell connected to 5GC only, the value of the “cellBarred” indication is always barred. For E-UTRAN connected to EPC only, the base station may omit the “cellBarred5GS” field, and the existence of “cellBarred5GS” can act as an indication whether the E-UTRAN connects to 5GC.

In one embodiment, a UE receives a system information block (SIB) from a base station. The SIB comprises a first indication of cell barring for a first core network with a level of service. In step 502 the UE determines whether a second indication of cell barring for a second core network is contained in the SIB. In step 503, the UE performs cell selection or cell reselection to a serving cell based on both the first indication and the second indication, wherein the serving cell is connected to the first core network or to the second core network or to both the first and the second core networks.

In another embodiment, a base station determines whether a serving cell supported by the base station is connected to a first core network with a level of service. In step 602, the base station generates a first indication that indicates cell barring for the first core network. In step 603, the base station generates a second indication that indicates cell barring for a second core network when the serving cell is connected to the second core network. In step 604, the base station broadcasts a system information block (SIB) comprising the first indication and the second indication, wherein the serving cell is connected to the first core network or to the second core network or to both the first and the second core networks.

Other embodiments and advantages are described in the detailed description below. This summary does not purport to define the invention. The invention is defined by the claims.

### BRIEF DESCRIPTION OP THE DRAWINGS

The accompanying drawings, where like numerals indicate like components, illustrate embodiments of the invention.

FIG. 1 illustrates an exemplary next generation system with multiple access and core networks and a user equipment (UE) performing cell selection or reselection in accordance with one novel aspect.

FIG. 2 illustrates simplified block diagrams of a user equipment (UE) and a base station (BS) in accordance with embodiments of the current invention.

FIG. 3 illustrates one embodiment of providing cell barring indication to UE in a next generation system with multiple access and core networks in accordance with one novel aspect.

FIG. 4 illustrates one embodiment of a UE performing cell selection or reselection in a next generation system with multiple access and core networks in accordance with one novel aspect.

FIG. 5 is a flow chart of a method of performing cell selection or reselection using cell barring indication from UE perspective in accordance with a novel aspect.

FIG. 6 is a flow chart of a method of providing cell barring indication to UE from network perspective in accordance with a novel aspect.

### DETAILED DESCRIPTION

Reference will now be made in detail to some embodiments of the invention, examples of which are illustrated in the accompanying drawings.

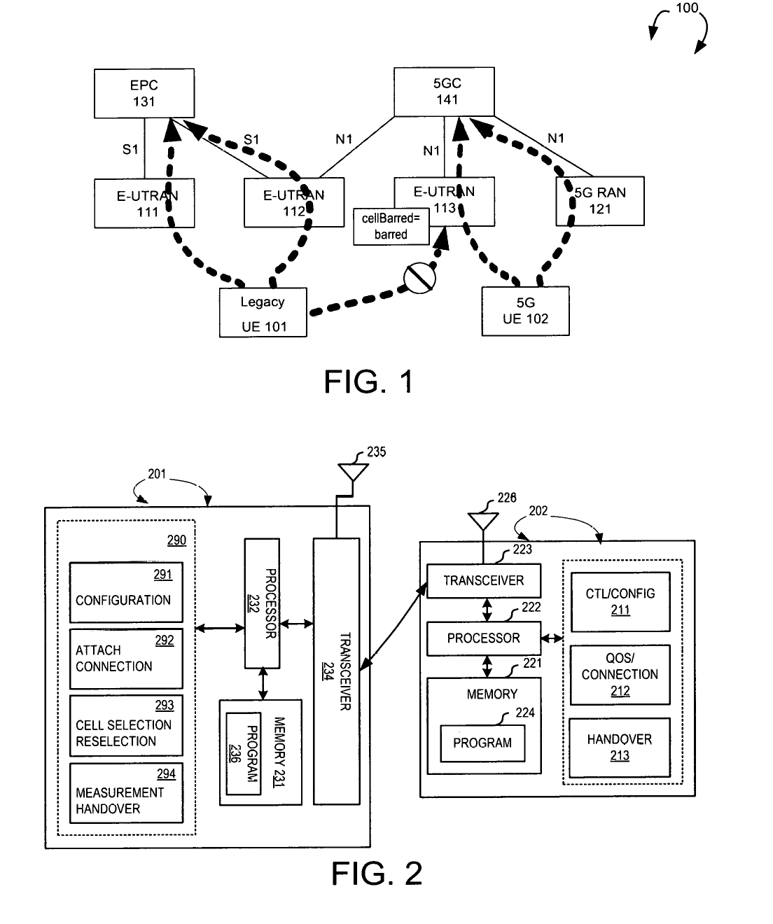

FIG. 1 illustrates an exemplary next generation 5G system 100 with multiple radio access and core networks and a user equipment (UE) performing cell selection or reselection in accordance with one novel aspect. Next generation mobile communication system 100 comprises an LTE 4G legacy UE 101, a new radio NR 5G UE 102, LTE radio access networks (RANs) E-UTRAN 111, 112, 113, a 5G RAN 121, a 4G evolved packet core network EPC 131, and a 5G core network 5GC 141. The radio access networks (RANs) provide radio access for UE 101 and UE 102 to the core networks via various radio access technologies (RATs). For example, UE 101 can access EPC 131 via E-UTRAN 111 or 112, and UE 102 can access 5GC 141 via E-UTRAN 113 or 5G RAN 121. UE 101/102 may be equipped with a single radio frequency (RF) module or transceiver or multiple RF modules or transceivers for services via different RATs/CNs. UE 101/102 may be a smart phone, a wearable device, an Internet of Things (IoT) device, a tablet, a machine-type communication (MTC) device, etc.

An E-UTRAN serving cell is capable of connecting to an evolved packet core (EPC) under 4G LTE, a 5G core (5GC) under 5G NR, or both. Different core networks support different Non-Access Stratum (NAS) level signaling. Legacy LTE UE only supports 4G NAS signaling, while NR UE supports both 4G and 5G NAS signaling. When a legacy LTE UE selects an E-UTRAN cell that is only connected to 5GC, the legacy LTE UE does not support 5G NAS signaling for accessing the 5GC. It is not clear how UE can detect whether a cell is connected to EPC only, 5GC only, or both. As a result, the legacy LTE UE cannot access the core network until it tries to select or reselect the E-UTRAN serving cell that is only connected the 5GC. In the example of FIG. 1, E-UTRAN 111 is only connected to EPC 131, E UTRAN 112 is connected to both EPC 131 and 5GC 141, and E-UTRAN 113 is only connected to 5GC 113. If legacy UE 101 selects or reselects E-UTRAN 113 as its serving cell that is only connected to 5GC 141, UE 101 cannot access 5GC 141 because it does not support 5G NAS signaling.

In accordance with one novel aspect, a cell barring indication “cellBarred” in system information block 1 (SIB1) is redefined to indicate “cell is barred for EPC”. In addition, a new cell barring indication “cellBarred5GS” is introduced to indicate “cell is barred for 5GC”. The existence of this new field can also act as an indication whether the cell is connected to 5GC. In the example of FIG. 1, for E-UTRAN 113 that is connected only to 5GC, the value of “cellBarred” should be always “barred”, because this cell will never be an acceptable cell for legacy UE 101. For E-UTRAN 111 that is connected only to EPC, the new indication “cellBarred5GS” is not included in SIB1. For E-UTRAN 112 that is connected to both EPC and 5GC, both indication “cellBarred” and “cellBarred5GS” can be used on demand for UEs attempting to access either to EPC or to 5GC. As a result, legacy UE 101 will not select or reselect E-UTRAN 113 at its serving cell. Legacy UE 101 can select or reselect E-UTRAN 111 or E-UTRAN 112 as its serving cell based on the cellBarred indication, and 5G UE 102 can select or reselect E-UTRAN 112, E-UTRAN 113, or 5G RAN 121 based on the cellBarred5GS indication. By introducing cell barring indications for both EPC and 5GC, each UE is able to select or reselect the proper serving cell and reduce unnecessary subsequent failure and signaling overhead.

FIG. 2 illustrates simplified block diagrams of a user equipment UE 201 and a base station DC 202 in accordance with embodiments of the current invention. BS 202 may have an antenna 226, which may transmit and receive radio signals. RF transceiver module 223, coupled with the antenna, may receive RF signals from antenna 226, convert them to baseband signals and send them to processor 222. RF transceiver 223 may also convert received baseband signals from processor 222, convert them to RF signals, and send out to antenna 226. Processor 222 may process the received baseband signals and invoke different functional modules to perform features in BS 202. Memory 221 may store program instructions and data 224 to control the operations of BS 202. BS 202 may also include a set of functional modules and control circuits, such as a control and configuration circuit 211 for control and configure system information including providing two cell barring indicators—“cellBarred” and “cellBarred5GS”— to UE, a connection circuit 212 for establish radio connection with UE, and a handover circuit 213 for sending handover commands to UE.

Similarly, UE 201 has an antenna 235, which may transmit and receive radio signals. RF transceiver module 234, coupled with the antenna, may receive RF signals from antenna 235, convert them to baseband signals and send them to processor 232. RF transceiver 234 may also convert received baseband signals from processor 232, convert them to RF signals, and send out to antenna 235. Processor 232 may process the received baseband signals and invoke different functional modules to perform features in the UE 201. Memory 231 may store program instructions and data 236 to control the operations of the UE 201. UE 201 may also include a set of function modules and control circuits that may carry out functional tasks of the present invention. A configuration circuit 291 may receive system configuration and control information including two different cell barring indications from the network, an attach and connection circuit 292 may attach to the network dud establish connection with a serving base station, a cell selection or reselection circuit 293 may perform cell selection and reselection based on cell barring indication provided by the network, and a measurement and handover circuit 294 may perform measurements and handle handover functions in the network.

The various function modules and control circuits may be implemented and configured by software, firmware, hardware, and combination thereof. The function modules and circuits, when executed by the processors via program instructions contained in the memory, interwork with each other to allow the base station and UE to perform embodiments and functional tasks and features in the network. In one example, each module or circuit comprises a processor (e.g., 222 or 232) together with corresponding program instructions.

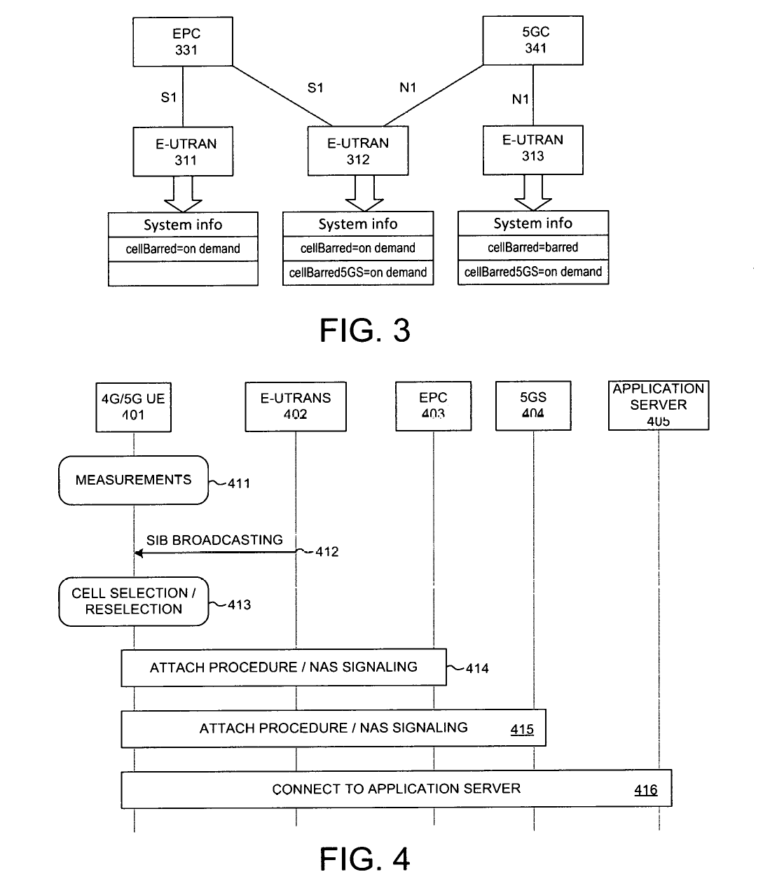

FIG. 3 illustrates one embodiment of providing cell barring indication to UE in a next generation system with multiple access and core networks in accordance with one novel aspect. The next generation mobile communication system comprises E-UTRAN 311, 312, 313, a 4G EPC 331, and a 5GC 341. EPC 331 supports 4G NAS signaling, and is connected to E-UTRAN 311 and E-UTRAN 312 via S1 signaling interface. 5GC 341 supports 5G NAS signaling, and is connected to E-UTRAN 312 and E-UTRAN 313 via N1 signaling interface. From E-UTRAN perspective, each E-UTRAN is connected to an EPC only, or to a 5GC only, or to both EPC and 5GC core networks. Each cell needs to provide cell barring information and service types to UEs in idle mode that attempt to camp on a cell and access the core network through the cell.

The action of camping on a cell is necessary to get access to some services. Three levels of services are defined for UE: Limited service (emergency calls, ETWS and CMAS on an accepted cell); Normal service (for public use on a suitable cell); Operator service (for operators only on a reserved cell). An “acceptable cell” is a cell on which the UE may camp to obtain limited service (to originate emergency calls and to receive notifications). Such a cell shall fulfill a minimum set of requirements, e.g., the cell is not barred and the cell selection criteria are fulfilled to initiate emergency call and to receive notifications in an E-UTRAN network. A “suitable cell” is a cell on which the UE may camp to obtain normal service. Such a cell shall fulfill a set of requirements including: the cell is part of the PLMN, the cell is not barred, and the cell selection criteria are fulfilled for normal service. A cell is barred if so indicated in the system information.

In accordance with one novel aspect, two cell barring indications are provided by the base station via the system information to UEs for cell selection or reselection purpose. A first indication is a “cellBarred” indication for EPC, which indicates wither UE is barred to access EPC core network, and a second indication is a “cellBarred5GS” indication for 5GC, which indicates whether UE is barred to access 5GC core network. For E-UTRAN cell connected to both EPC and 5GC, the two indications are determined on demand, based on network preference and congestion control. For example, E UTRAN 312 is connected to both EPC 331 and 5GC 341, and both “cellBarred” and “cellBarred5GS” are determined on demand by the network. For E-UTRAN cell connected to 5GC only, it will never be an “accepted cell” for legacy UE, therefore, the value of the “cellBarred” indication is always barred. For example, E-UTRAN 313 is connected to 5GC 341 only, so “cellBarred” is always set to barred, while “cellBarred5GS” is set on demand. For E-UTRAN cell connected to EPC only, the base station may omit the “cellBarred5GS” field, and the existence of “cellBarred5GS” can act as an indication whether the E-UTRAN connects to 5GC. For example, E-UTRAN 311 is connected to EPC 331 only, so “cellBarred” is set on demand, while “cellBarred5GS” is not provided by the system information.

FIG. 4 illustrates one embodiment of a UE performing cell selection or reselection in a next generation system with multiple access and core networks in accordance with one novel aspect. In the embodiment of FIG. 4, UE 401 can be a legacy 4G UE or an NR 5G UE. In step 411, UE 401 is in idle mode and performs measurements for cell selection and reselection purposes. In step 412, UE 401 receives system information (SI) broadcasted from the E-UTRAN networks 402. The SI comprises different system information blocks including SIB 1. In step 413, UE 401 performs cell selection or reselection. The UE will select a suitable cell based on idle mode measurements and cell selection criteria. When camped on a cell, the UE regularly search for a better cell according to the cell reselection criteria. If a better cell is found, that cell is selected. For normal service, the UE camps on a suitable cell so that the UE can receive system information from the PLMN and can receive other AS and NAS information. In accordance with one novel aspect, the cell selection or reselection is also based on two cell barring indications contained in SIB1.

If UE 401 is a legacy UE, then the UE only obtains the “cellBarred” indication and checks whether it is barred from the E-UTRAN cell. If the E-UTRAN cell is only connected to 5GC, then UE 401 will be barred and UE 401 will not select or reselect such E-UTRAN. If UE 401 is an NR UE, then the UE obtains both “cellBarred” and “cellBarred5GS” indications and checks whether it is barred from the E-UTRAN cell. If the E-UTRAN is only connected to EPC, then UE 401 will not receive the “cellBarred5GS” indication and be able to know that. If UE 401 is not barred by at least one of the indications and if the cell selection criteria are satisfied, then UE 401 selects the cell successfully. In step 414, UE 401 attaches to EPC 403 and receives 4G NAS signaling accordingly. This happens if UE 401 is a legacy UE and the cell is not barred for EPC, or if UE 401 is a 5G-capable UE and the cell is barred for 5GS due to preference. In step 415, UE 401 attaches to 5GC 404 and receives 5G NAS signaling accordingly. This happens if UE 401 is a 5G-capable UE and the cell is not barred for 5GS. In step 416, UE 401 can connect to other application servers 405 to receive different services. By introducing cell barring indications for both EPC and 5GC, each UE is able to select or reselect the proper serving cell and reduce unnecessary subsequent failure and signaling overhead.

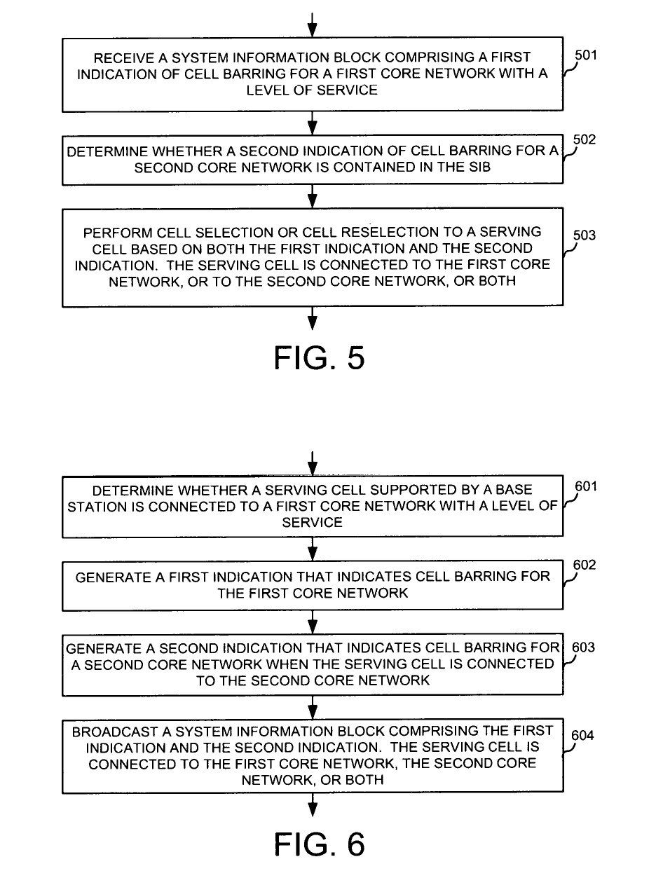

FIG. 5 is a flow chart of a method of performing cell selection or reselection using cell barring indication from UE perspective in accordance with a novel aspect. In step 501, a UE receives d system information block (SIB). The SIB comprises a first indication of cell barring for a first core network with a level of service. In step 502 the UE determines whether a second indication of cell barring for a second core network is contained in the SIB. In step 503, the UE performs cell selection or cell reselection to a serving cell based on both the first indication and the second indication, wherein the serving cell is connected to the first core network or to the second core network or to both the first and the second core networks.

FIG. 6 is a flow chart of a method of providing cell barring indication to UE from network perspective in accordance with a novel aspect. In step 601, a base station determines whether a serving cell supported by the base station is connected to a first core network with a level of service. In step 602, the base station generates a first indication that indicates cell barring for the first core network. In step 603, the base station generates a second indication that indicates cell barring for a second core network when the serving cell is connected to the second core network. In step 604, the base station broadcasts a system information block (SIB) comprising the first indication and the second indication, wherein the serving cell is connected to the first core network or to the second core network or to both the first and the second core networks.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
receiving a system information block (SIB) by a user equipment (UE), wherein the SIB comprises a first indication of cell barring for a first core network with a level of service;
determining whether a second indication of cell barring for a second core network is contained in the SIB; and
performing cell selection or cell reselection to a serving cell based on both the first indication and the second indication, wherein the serving cell is connected to the first core network or to the second core network or to both the first and the second core networks.

2. The method of claim 1, wherein the serving cell is an evolved universal terrestrial radio access network (E-UTRAN) serving cell.

3. The method of claim 1, wherein the first core network is an Evolved Packet Core (EPC) network.

4. The method of claim 3, wherein the first indication always indicates cell barring if the serving cell is not connected to the EPC network.

5. The method of claim 1, wherein the second core network is a 5G Core (5GC) network.

6. The method of claim 5, wherein the second indication does not exist in the SIB if the serving cell is not connected to the 5GC network.

7. The method of claim 1, wherein the level of service comprises at lease no service, limited service, normal service, and operator service.

8. A User Equipment (UE), comprising:
a radio frequency (RF) receiver that receives a system information block (SIB), wherein the SIB comprises a first indication of cell barring for a first core network with a level of service;
a configuration circuit that determines whether a second indication of cell barring for a second core network is contained in the SIB, and
a cell selection or reselection circuit that performs cell selection or cell reselection to a serving cell based on both the first indication and the second indication, wherein the serving cell is connected to the first core network or to the second core network or to both the first and the second core networks.

9. The UE of claim 8, wherein the serving cell is an evolved universal terrestrial radio access network (E-UTRAN) serving cell.

10. The UE of claim 8, wherein the first core network is an Evolved Packet Core (EPC) network.

11. The UE of claim 10, wherein the first indication always indicates cell barring if the serving cell is not connected to the EPC network.

12. The UE of claim 8, wherein the second core network is a 5G Core (5GC) network.

13. The UE of claim 12, wherein the second indication does not exist in the SIB if the serving cell is not connected to the 5GC network.

14. The UE of claim 8, wherein the level of service comprises at lease no service, limited service, normal service, and operator service.

15. A method, comprising:
determining whether a serving cell supported by a base station is connected to a first core network with a level of service;
generating a first indication that indicates cell barring for the first core network;
generating a second indication that indicates cell barring for a second core network when the serving cell is connected to the second core network; and
broadcasting a system information block (SIB) comprising the first indication and the second indication, wherein the serving cell is connected to the first core network or to the second core network or to both the first and the second core networks.

16. The method of claim 15, wherein the serving cell is an evolved universal terrestrial radio access network (E-UTRAN) serving cell.

17. The method of claim 15, wherein the first core network is an Evolved Packet Core (EPC) network.

18. The method of claim 17, wherein the first indication always indicates cell barring if the serving cell is not connected to the EPC network.

19. The method of claim 15, wherein the second core network is a 5G Core (5GC) network.

20. The method of claim 19, wherein the second indication is not inserted into the SIB if the serving cell is not connected to the 5GC network.
